(19) United States
(12) Patent Application Publication
(10) Pub. No.: US 2016/0108968 A1
(43) Pub. Date: Apr. 21, 2016

(54) STOPPER PIECE AND BEARING APPARATUS

(71) Applicant: SHOWA CORPORATION, Gyoda-shi (JP)

(72) Inventor: Kazuhide KOGUCHI, Haga-gun (JP)

(73) Assignee: SHOWA CORPORATION, Gyoda-shi (JP)

(21) Appl. No.: 14/867,703

(22) Filed: Sep. 28, 2015

(30) Foreign Application Priority Data
Oct. 20, 2014 (JP) 2014-213539

(51) Int. Cl. F16C 41/00; F16C 19/52

(52) U.S. Cl. CPC F16C 41/001; F16C 19/527

(57) ABSTRACT

To provide a stopper piece and a bearing apparatus capable of stopping the rotation of a shaft member to which a bearing and so on are fitted by using a tool. A stopper piece according to the present invention is a cylindrical stopper piece which is fitted over the shaft member of the propeller shaft with the bearing, one end face of which contacts with the bearing to prevent movement of the bearing, which includes a pair of protruding portions protruding from the other end face along the shaft member to interpose the shaft member, in which outer surfaces of the pair of protruding portions are flat surfaces directed to opposite directions as well as parallel to each other.

### CROSS-REFERENCE TO RELATED APPLICATIONS

This application claims the benefit of Japanese Patent Application JP 2014-213539, filed Oct. 20, 2014, the entire content of which is hereby incorporated by reference, the same as if set forth at length.

### BACKGROUND OF THE INVENTION

1. Field of the Invention

The present invention relates to a stopper piece and a bearing apparatus.

2. Description of Related Art

A propeller shaft has been used as a member connecting a transmission mounted in a front section of a vehicle and a final drive gear mounted in a rear section of the vehicle to transmit the torque.

As a distance between the transmission and the final drive gear is not fixed and rotation centers of an output shaft of the transmission and an input shaft of the final drive gear are not on the same axis, a universal joint is provided on both ends of the propeller shaft.

The universal joint provided on the both ends of the propeller shaft is commonly connected to the tubing by welding and so on before installing the propeller shaft and is connected to the transmission and so on by fastening bolts when installing the propeller shaft to a companion flange of the transmission and final drive gear.

Then, the process of tightening the bolts with a predetermined torque is performed by a torque wrench after the above fastening of the bolts for securing the tightening torque of the bolts.

Here, the vehicle body is hanged up when installing the propeller shaft to the vehicle body, therefore, input and output shafts of the transmission and so on may be in an idle condition. Accordingly, the propeller shaft may rotate when the process of tightening the bolts and that the work efficiency is deteriorated.

In view of the above, a rotation stopper having a hexagonal shape in cross section is formed in a stab shaft (shaft member) of a constant velocity joint in JP-A-2009-227028 (Patent Document 1). In such structure, the rotation of the propeller shaft is prevented by inserting a tool into the rotation stopper of the shaft member and holding the tool.

### SUMMARY OF THE INVENTION

Incidentally, the propeller shaft may be divided at an intermediate portion and the constant velocity joint may be provided here. In the propeller shaft divided at the intermediate portion, the shaft member of the constant velocity joint is rotatably supported by an intermediate bearing structure mounted to the vehicle body.

The intermediate bearing structure is provided with an intermediate bearing apparatus (including an intermediate bearing fitted over the shaft member, a stopper piece regulating positional displacement of the intermediate bearing and so on) and a bracket assembly fixed to the vehicle body and holding the intermediate bearing apparatus.

Accordingly, it is difficult to apply the rotation stopper described in Patent Document 1 in the shaft member which is rotatably supported by the bearing structure because the bearing and the stopper piece are fitted over the shaft member.

The present invention has been created to solve the above problems, and an object thereof is to provide a stopper piece and a bearing apparatus capable of stopping the rotation of the shaft member to which the bearing and so on are fitted by using a tool.

According to an embodiment of the present invention, there is provided a cylindrical stopper piece fitted over a shaft member of a propeller shaft with a bearing, wherein one end face of the stopper piece contacts with the bearing to prevent movement of the bearing, the stopper piece including a pair of protruding portions protruding from other end face of the stopper piece along the shaft member to interpose the shaft member between the pair of protruding portions, wherein outer surfaces of the pair of protruding portions are flat surfaces directed to opposite directions and being parallel to each other.

In the stopper piece according to the embodiment, a spanner for the same width (width across flats) as the outer surfaces of the pair of protruding portions is prepared, and the spanner is inserted into the pair of protruding portions, thereby engaging the outer surfaces of the pair of protruding portions with the spanner. Then, the rotational movement of the shaft member to which the stopper piece is fitted can be suppressed by holding the spanner.

Accordingly, even when the bolts fastening the universal joint to the transmission and so on are tightened by the torque wrench with a predetermined torque when installing the propeller shaft to the vehicle body, the propeller shaft is not rotationally moved and deterioration in process efficiency of tightening bolts can be avoided.

According to another embodiment, there is provided a cylindrical stopper piece fitted over a shaft member of a propeller shaft with a bearing, wherein one end face of the stopper piece contacts with the bearing to prevent movement of the bearing, the stopper piece including ridges or grooves extending in a radial direction of the shaft member and provided on other end face of the stopper piece, with which a tool can be engaged.

In the stopper piece according to another embodiment, a dedicated tool in which grooves (or ridges) corresponding to the ridges (or grooves) are formed is prepared and the ridges (or grooves) of the stopper piece are fitted to the grooves (or ridges) of the tool to hold the tool.

Here, the ridges (or grooves) of the stopper piece extend in the normal direction with respect to the outer peripheral surface of the shaft member, therefore, the ridges (or grooves) of the stopper piece are locked with the grooves (or ridges) of the tool when the shaft member rotationally moves in the circumferential direction.

Accordingly, even when the bolts fastening the universal joint to the transmission and so on are tightened by the torque wrench with a predetermined torque, the rotational movement of the shaft member (propeller shaft) is suppressed and deterioration in process efficiency of tightening bolts can be avoided.

According to further another embodiment of the present invention, there is provided a cylindrical stopper piece fitted over a shaft member of a propeller shaft with a bearing, wherein one end face of the stopper piece contacts with the bearing to prevent movement of the bearing, the stopper piece including locking holes or locking projections with which a tool can be engaged and which are provided on other end face of the stopper piece.

In the locking holes (locking projections) of the stopper piece according to further another embodiment, a dedicated tool in which projections (or holes) corresponding to the locking holes (or locking projections) are formed is prepared and the locking holes (or locking projections) of the stopper piece are fitted to the projections (or holes) of the tool to hold the tool.

Accordingly, the holes (or projections) of the stopper piece are locked with the projections (or holes) of the tool when the shaft member rotationally moves in the circumferential direction.

As a result, even when the bolts fastening the universal joint to the transmission and so on are tightened by the torque wrench with a predetermined torque, the rotational movement of the shaft member (propeller shaft) is suppressed and deterioration in process efficiency of tightening bolts can be avoided.

According to an embodiment of the present invention, there is provided a bearing apparatus for rotatably supporting a shaft member including a bearing fitted over the shaft member and rotatably supporting a propeller shaft, a vibration absorbing member fitted over the bearing and absorbing vibration of the propeller shaft and the above stopper piece.

In the above bearing apparatus, the stopper piece is prevented from being rotationally moved by the tool, therefore, even when the bolts fastening the universal joint to the transmission and so on are tightened by the torque wrench with a predetermined torque, the rotational movement of the shaft member (propeller shaft) is suppressed and deterioration in process efficiency of tightening bolts can be avoided.

According to the embodiments of the present invention, it is possible to provide the stopper piece and the bearing apparatus capable of stopping the rotation of the shaft member to which the bearing and so on are fitted by using a tool.

### BRIEF DESCRIPTION OF THE DRAWINGS

FIG. 1 is a plan view showing a propeller shaft and a stopper piece according to a first embodiment;

FIG. 2 is a front view seen from the front direction by extracting a flange yoke alone;

FIG. 3 is an enlarged view of a range surrounded by a frame line A of FIG. 1;

FIG. 4 is a cross sectional view taken along C-C line of FIG. 1;

FIG. 5 is a rear view seen from the rear direction by extracting a projection of a stopper piece alone; and

FIG. 6A is a rear view of a stopper piece according to a second embodiment, FIG. 6B is a cross sectional view taken along D-D line of FIG. 6A, FIG. 6C is a rear view of a stopper piece according to a modification example of the second embodiment, FIG. 6D is a cross sectional view taken along E-E line of FIG. 6C, FIG. 6E is a rear view of a stopper piece according to a third embodiment and FIG. 6F is across sectional view taken along F-F line of FIG. 6E.

### DESCRIPTION OF EMBODIMENTS

Embodiment of the present invention will be suitably explained with reference to the drawings.

In the explanation of the embodiment, a propeller shaft 1 will be explained first, then, an intermediate bearing structure 10 having a stopper piece 50 according to the embodiment will be explained.

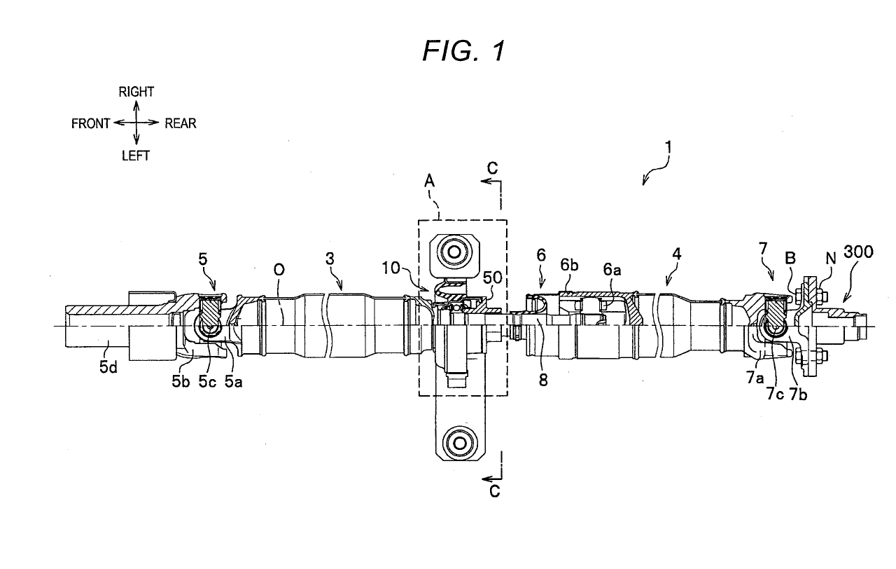

As shown in FIG. 1, a propeller shaft 1 is installed on the vehicle, which transmits the power outputted from a transmission (not shown) installed on a front section of the vehicle to a final drive gear installed in a rear section of the vehicle.

The propeller shaft 1 has a two-piece structure which is divided at an intermediate portion.

The propeller shaft 1 includes a first propeller shaft 3 connecting to a transmission (not shown) through a first cardan joint 5, a second propeller shaft 4 connecting to the final drive gear (not shown) through a second cardan joint 7 and a constant velocity joint 6 connecting the first propeller shaft 3 and the second propeller shaft 4.

The first propeller shaft 3 and the second propeller shaft 4 are hollow steel tubing.

The first cardan joint 5 includes a stub yoke 5a welded at a front end of the first propeller shaft 3, a sleeve yoke 5b connecting to an output shaft (not shown) of the transmission and a trunnion 5c connecting the stub yoke 5a to the sleeve york 5b.

In the sleeve yoke 5b, a cylindrical connecting portion 5d protruding forward is formed. The output shaft of the transmission is inserted into the connecting portion 5d, and the sleeve yoke 5b and the output shaft of the transmission are integrally rotated.

The second cardan joint 7 includes a stub yoke 7a welded at a rear end of the second propeller shaft 4, a flange yoke 7b combined with a companion flange 300 by the tightening of fastenings (bolts B and nuts N) and a trunnion 7c connecting the stub yoke 7a and the flange yoke 7b.

The companion flange 300 is fixed to an input shaft (not shown) of the final drive gear by spline fitting and fixed by locking nuts before the propeller shaft 1 is installed to the vehicle body.

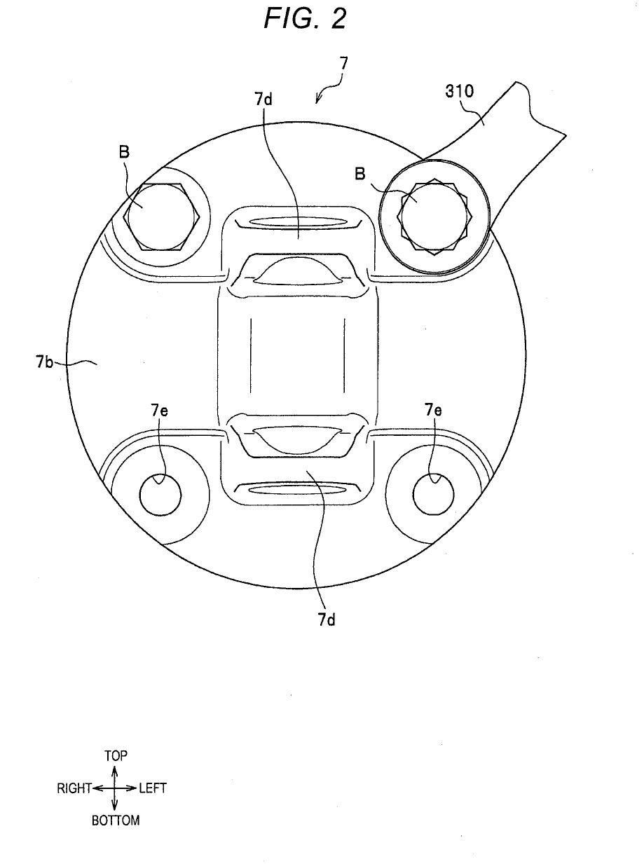

As shown in FIG. 2, a pair of arm. portions 7d supporting the trunnion 7c is formed in the center of the flange yoke 7b. Four bolt holes 7e (only two holes are shown) piercing an end face of the flange yoke 7b in the front and rear direction are formed.

Then, a rear face of the flange yoke 7b is connected to a front face of the companion flange 300 when the propeller shaft 1 is installed to the vehicle body. Next, the bolts B are inserted into the bolt holes 7e of the flange yoke 7b and the companion flange 300 and to be tightened to the nuts N (see FIG. 1). Accordingly, the flange yoke 7b and the companion flange 300 are combined by being tightened by the bolts B and the nuts N.

After the bolts B and the nuts N are tightened, the bolts B and the nuts N is secured by tightening the bolts B by a torque wrench 310 with a predetermined torque as shown in FIG. 2.

The constant velocity joint 6 is a tripod joint including an approximately cylindrical stub shaft (shaft member) 8 welded in a rear portion of the first propeller shaft 3 and extending backward, a cylindrical outer race 6a welded in a front section of the second propeller shaft 4 and a trunnion kit 6b provided in a rear end of the stub shaft 8.

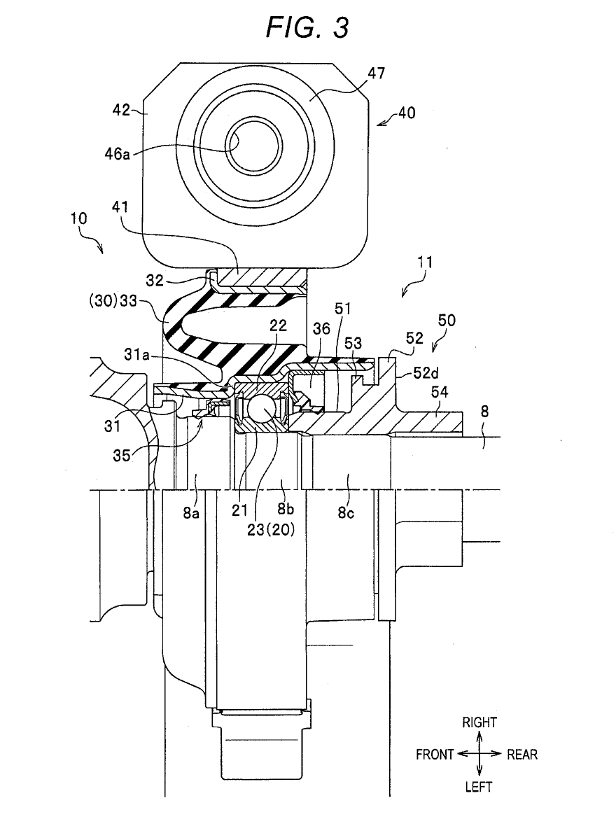

As shown in FIG. 3, in the front side of the stub shaft 8, a large-diameter portion 8a, a first fitted portion 8b and a second fitted portion 8c are formed from the front direction toward the rear direction as a structure for mounting the intermediate bearing structure 10.

An outer diameter of the large-diameter portion 8a is formed to be larger than an inner diameter of an inner race 21 of an intermediate bearing 20. The first fitted portion 8b is a portion fitted into the inner race 21 of the intermediate bearing 20. An outer diameter of the first fitted portion 8b is formed to be slightly larger than the inner diameter of the inner race 21 for preventing movement of the inner race 21.

The first fitted portion 8b is a portion to be fitted into a later-described stopper piece 50. The outer diameter of the first fitted portion 8b is formed to be slightly larger than an inner diameter of the stopper piece 50 for preventing movement of the stopper piece 50.

The intermediate bearing structure 10 is for holding an intermediate portion of the propeller shaft 1 in the vehicle body. The intermediate bearing structure 10 includes an intermediate bearing apparatus 11 for rotatably supporting the propeller shaft 1 and a bracket assembly 40 fixed to the vehicle body and holding the intermediate bearing apparatus 11.

The intermediate bearing apparatus 11 also includes the intermediate bearing 20 fitted over the stub shaft 8, a vibration absorbing member 30 fitted over the intermediate bearing 20 and the cylindrical stopper piece 50 fitted over the stub shaft 8 with the intermediate bearing 20, a front end face of which contacts with the intermediate bearing 20.

The intermediate bearing 20 is a radial ball bearing in which plural balls 23 are provided between the inner race 21 and an outer race 22. The inner race 21 of the intermediate bearing 20 is fitted over the first fitted portion 8b of the stub shaft 8. A front face of the inner race 21 contacts with a rear face of the large-diameter portion 8a, which regulates the movement of the intermediate bearing 20 to the front direction.

The vibration absorbing member 30 is a member for absorbing the imbalance in the propeller shaft 1 and vibration generated in the first and second cardan joints 5 and 7 to thereby reduce the vibration transmitted to the vehicle body.

The vibration absorbing member 30 includes a cylindrical inner ring 31 fitted over the outer race 22 of the intermediate bearing 20, a cylindrical outer ring 32 surrounding the inner ring 31 on the outer peripheral side of the inner ring 31 and a insulator 33 interposing between the inner ring 31 and the outer ring 32 to absorb the vibration.

The insulator 33 is a cylindrical part made of rubber having elasticity, which is integrally formed with the inner ring 31 and the outer ring 32 by insert molding.

The inner ring 31 is formed to be longer than the outer race 22 of the intermediate bearing 20 in the front and rear direction.

In a front part side of the inner ring 31, a step portion 31a on which a front end face of the outer race 22 of the intermediate bearing 20 retains is formed.

Moreover, sealing members 35 and 36 for sealing the intermediate bearing 20 from the front and rear direction are fitted into the inner ring 31, which prevent infiltration of muddy water, dust and so on into the intermediate bearing 20.

The sealing member 36 provided in the rear direction of the intermediate bearing 20 contacts to a rear face of the outer race 22 of the intermediate bearing 20. Accordingly, the outer race 22 of the intermediate bearing 20 is sandwiched between the sealing member 36 and the step portion 31a of the inner ring 31 in the front and rear direction, which can regulate the positional displacement of the vibration absorbing member 30 in the front and rear direction.

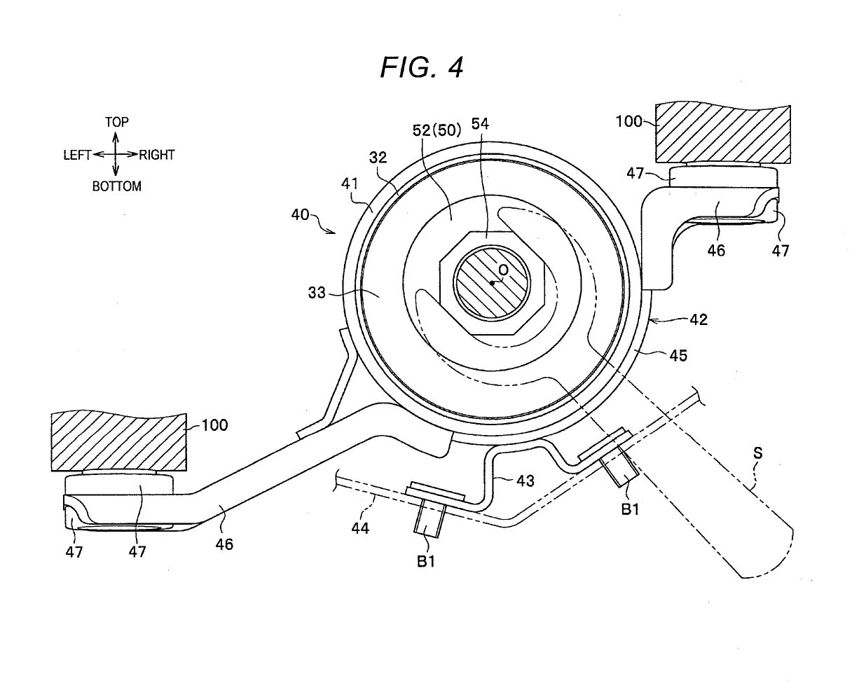

As shown in FIG. 4, the bracket assembly 40 includes a cylindrical ring 41 supporting the intermediate bearing 20 through the vibration absorbing member 30, a bracket 42 fixed to an outer peripheral side of the ring 41, a convex stay 43 fixed to a lower face side of the bracket 42 and a heat protector 44 attached to the stay 43.

The ring 41 is a metal member and the outer ring 32 of the vibration absorbing member 30 is press-fitted into the ring 41 to thereby fix the vibration absorbing member 30 into the ring 41.

The bracket 42 is a metal part formed by bending a piece of metal plate. The bracket 42 includes an arc portion 45 extending along an outer peripheral surface of the ring 41 and a pair of seat surfaces 46 and 46 extending from both ends of the arc portion 45 toward the outside in a vehicle width direction which are integrally formed.

The arc portion 45 is integrally formed with the ring 41 by spot welding.

In the pair of seat surfaces 46 and 46, through holes 44a (see FIG. 3) piercing in the top and bottom direction are formed. Then, the pair of seat surfaces 46 and 46 are tightened by bolts (not shown) and screwed to a bottom portion 100 of the vehicle to thereby fix the bracket 42 to the vehicle body.

In the present embodiment, rubber mounts 47 are sandwiched between both upper and lower surfaces of the pair of seat surfaces 46 and 46, which reduces vibration of the propeller shaft 1 to be transmitted to the vehicle body.

The stay 43 is a member for attaching the heat protector 44 to the bracket 42, which is fixed to the bracket 42 by spot welding. In both ends of the stay 43, through holes (not shown) into which shaft portions of bolts B1 pierce for fixing the heat protector 44 to the stay 43 are formed.

The heat protector 44 is a member for preventing heat of an exhaust pipe from propagating to the insulator 33 and the sealing members 35, 36, which is tightened by nuts (not shown) screwed to the bolts B1 to be fixed to the stay 43.

As shown in FIG. 3, the stopper piece 50 is a cylindrical metal part having functions for preventing movement of the intermediate bearing 20 from the stub shaft 8 and preventing infiltration of muddy water and so on into the intermediate bearing 20.

The stopper piece 50 includes a cylindrical fitting portion 51 fitted over the first fitted portion 8b of the stub shaft 8, a flange portion 52 provided on a rear side of the fitting portion 51 and covering an opening of the inner ring 31 of the vibration absorbing member 30, an annular portion 53 having an annular shape extending to the outside in the radial direction in an annular shape along an outer peripheral surface of the fitting portion 51 and a tubular projection 54 protruding rearward from a rear end face (the other end face) 52a of the flange portion 52 along the stub shaft 8.

A front end face (one end face) of the fitting portion 51 contacts with the inner race 21 of the intermediate bearing 20. Accordingly, the movement of the intermediate bearing 20 from the stub shaft 8 is prevented.

An interval between the flange portion 52 and a rear end edge of the inner ring 31 arranged in the front direction of the flange 52 is a gap into which water or the like hardly enters due to the labyrinth effect. The water or the like hardly enters to the inner peripheral side of the inner ring 31 from between the inner ring 31 and the flange portion 52.

The annular portion 53 is apart from the flange portion 52 in the front direction. Accordingly, if water or the like enters to the inner peripheral side of the inner ring 31, the water enters into a groove between the flange portion 52 and the annular portion 53, then, the water flows downward along the groove to be discharged to the outside of the inner ring 31.

The projection 54 is a portion to be engaged with a spanner S.

As shown in FIG. 4, an outer peripheral surface of the projection 54 is formed to have an approximately octagonal shape in cross section.

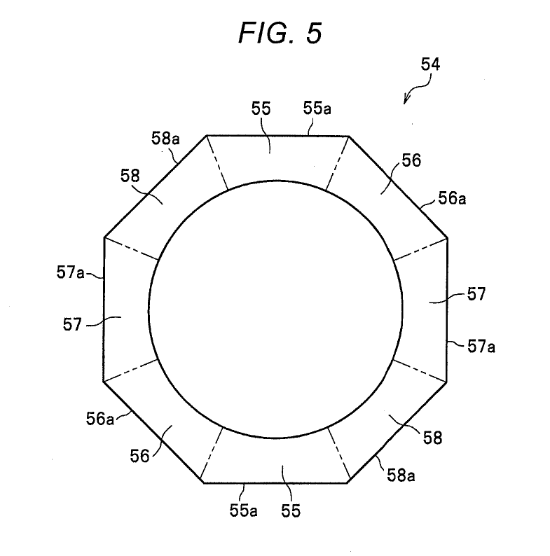

The structure of the projection 54 will be explained in detail. As shown in FIG. 5, the projection 54 has four pairs of protruding portions 55 to 58 projecting from a rear end face 52a of the flange portion 52 along the stub shaft 8 so as to interpose the stub shaft 8.

Respective pairs of protruding portions 55 to 58 are arranged by being shifted in a circumferential direction to one another so as to be connected to pairs of protruding portions 55 to 58 which are adjacent to each other in a circumferential direction.

Two-dot chain lines shown in FIG. 5 are lines indicating boundaries between pairs of protruding portions 55 to 58 adjacent to each other in the circumferential direction.

Furthermore, outer surfaces 55a and 55a of the pair of protruding portions 55 are flat surfaces directed to opposite directions as well as parallel to each other. Outer surfaces 56a to 58a of other pairs of protruding portions 56 to 58 are also flat surfaces directed to opposite directions as well as parallel to each other.

In the above structure, the spanner S for the same width (width across flats) as the outer surfaces 55a to 58a of the pairs of protruding portions 55 to 58 is prepared. When the spanner S is inserted to the projection 54, the outer surfaces of any one pair of protruding portions in the pairs of protruding portions 55 to 58 are engaged with the spanner S as shown in FIG. 4.

Accordingly, when the propeller shaft 1 is installed to the vehicle body as described above, the rotational movement of the propeller shaft 1 is suppressed at the process of connecting the bolts B for tightening the flange yoke 7b to the companion flange 300 by the torque wrench 310 with the predetermined torque, which avoids deterioration in process efficiency of tightening the bolts B.

As methods of forming the projection 54, machining work, cold forging, sintered alloy and so on can be cited, which are not limited in the present invention.

The stopper piece 50 according to the first embodiment has been explained as the above, however, the pair of protruding portions in the present invention is not limited to the example explained in the embodiment.

The four pairs of protruding portions 55 to 58 are included in the above embodiment, however, it is possible to allow the spanner S to be engaged to prevent the rotational movement of the propeller shaft 1 by forming one pair of protruding portions. Accordingly, the present invention can be the stopper piece 50 in which one pair of protruding portions is formed.

In the plural pairs of protruding portions formed in the above embodiment, pairs of protruding portions adjacent to each other in the circumference direction are connected to each other, however, the present invention is not limited to this, and it is not always necessary that pairs of protruding portions adjacent to each other in the circumference direction are connected to each other. However, it is preferable that the pairs of protruding portions adjacent to each other in the circumference direction are connected to each other because the rigidity of pairs of protruding portions is increased.

Also in the above embodiment, the tripod-type constant velocity joint 6 has been explained as an example of a universal joint held by the intermediate bearing structure 10, however, the present invention is not limited to this. Any of a double offset type, a cross groove type and a birfield type joints can be used in addition to a cardan joint.

Furthermore, the stub shaft 8 arranged in the intermediate portion of the propeller shaft 1 has been explained as an example of a “shaft member” described in claims in the above embodiment, however, the present invention is not limited to this. The stub shaft (shaft member) arranged on a front end side or a rear end side of the propeller shaft 1 can be applied as long as the shaft member is fitted over the bearing.

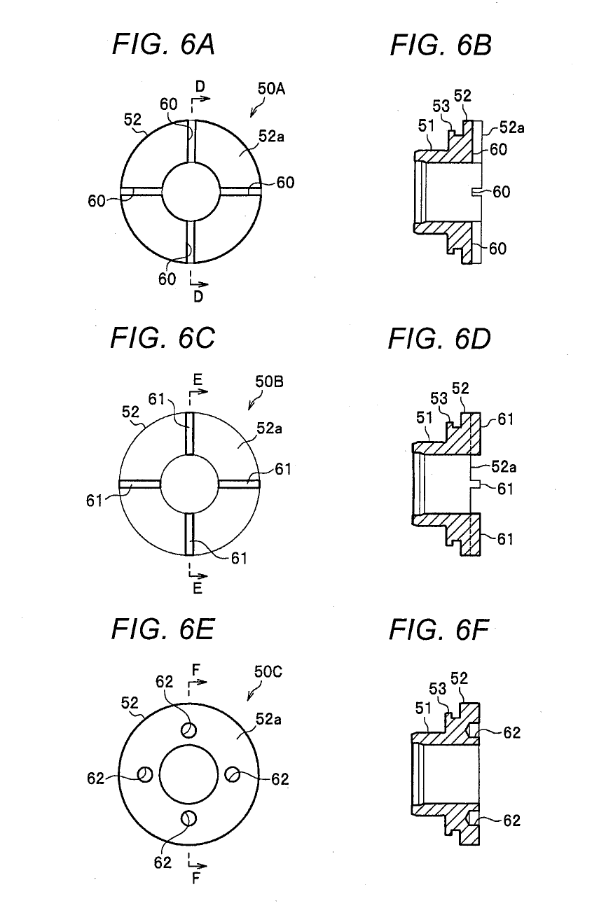

The first embodiment has been explained as the above. Next, stopper pieces 50A and 50C according to a second embodiment and a third embodiment will be explained with reference to FIGS. 6A to 6F.

As shown in FIGS. 6A and 6B, in the stopper piece 50A according to the second embodiment, four ridges 60 extending in a normal direction with respect to an outer peripheral surface of the stub shaft 8 are formed on the rear end face 52a of the flange portion 52 around the stub shaft 8 at intervals of approximately 90 degrees.

In the stopper piece 50A according to the second embodiment, a dedicated tool in which grooves corresponding to the ridges 60 are formed is prepared and the ridges 60 of the stopper piece 50A are fitted to the grooves of the tool to hold the tool.

According to the above, the ridges 60 of the stopper piece 50A extend in the normal direction with respect to the outer peripheral face of the stub shaft 8, therefore, the ridges 60 are locked in the grooves of the tool when the ridges 60 move in the circumferential direction, which can suppress the rotational movement of the propeller shaft 1.

The example in which the ridges 60 are formed on the rear end face 52a of the flange portion 52 has been cited in the second embodiment, and it is also preferable to form grooves 61 extending in the normal direction with respect to the outer peripheral surface of the stub shaft 8 as in a stopper piece 50B shown in FIGS. 6C and 6D.

The number of ridges 60 or the grooves 61 is not limited to four, and one ridge 60 or one groove 61 may be formed.

As shown in FIG. 6E and 6F, in a stopper piece 50C according to a third embodiment, four locking holes 62 which are recessed toward the front are formed on the rear end face 52a of the flange portion 52 around the stub shaft 8 at intervals of approximately 90 degrees.

In the stopper piece C, a dedicated tool in which projections corresponding to the locking holes 62 are formed is prepared and the projections of the tool are fitted to the locking hole 62 of the stopper piece 50C to hold the tool, thereby locking the projections of the tool and suppressing rotational movement of the propeller shaft 1.

As a modification example of the third embodiment, locking projections projecting backward from the rear end face 52a of the flange portion 52 may be formed. In the present invention, the number of locking holes or locking projections formed on the rear end face of the flange portion 52 is not limited to four, and one locking hole or one locking projection may be formed.

What is claimed is:

1. A cylindrical stopper piece fitted over a shaft member of a propeller shaft with a bearing, wherein one end face of the stopper piece contacts with the bearing to prevent movement of the bearing, the stopper piece comprising:
a pair of protruding portions protruding from other end face of the stopper piece along the shaft member to interpose the shaft member between the pair of protruding portions,
wherein outer surfaces of the pair of protruding portions are flat surfaces directed to opposite directions and being parallel to each other.

2. A cylindrical stopper piece fitted over a shaft member of a propeller shaft with a bearing, wherein one end face of the stopper piece contacts with the bearing to prevent movement of the bearing, the stopper piece comprising:
ridges or grooves extending in a radial direction of the shaft member and provided on other end face of the stopper piece, with which a tool can be engaged.

3. A cylindrical stopper piece fitted over a shaft member of a propeller shaft with a bearing, wherein one end face of the stopper piece contacts with the bearing to prevent movement of the bearing, the stopper piece comprising:
locking holes or locking projections with which a tool can be engaged and which are provided on other end face of the stopper piece.

4. A bearing apparatus for rotatably supporting a shaft member, comprising:
a bearing fitted over the shaft member and rotatably supporting a propeller shaft;
a vibration absorbing member fitted over the bearing and absorbing vibration of the propeller shaft; and
the stopper piece according to claim 1.

5. A bearing apparatus for rotatably supporting a shaft member, comprising:
a bearing fitted over the shaft member and rotatably supporting a propeller shaft;
a vibration absorbing member fitted over the bearing and absorbing vibration of the propeller shaft; and
the stopper piece according to claim 2.

6. A bearing apparatus for rotatably supporting a shaft member, comprising:
a bearing fitted over the shaft member and rotatably supporting a propeller shaft;
a vibration absorbing member fitted over the bearing and absorbing vibration of the propeller shaft; and
the stopper piece according to claim 3.
